(19) United States
(12) Patent Application Publication
(10) Pub. No.: US 2026/0321836 A1
(43) Pub. Date: Oct. 15, 2026

(54) BATTERY HOUSING FOR ACCOMMODATING A PLURALITY OF BATTERY COMPONENTS, BATTERY WITH A BATTERY HOUSING, MOTOR VEHICLE WITH A BATTERY

(71) Applicant: KAUTEX TEXTRON GmbH & Co. KG, Bonn (DE)

(72) Inventors: Henryk WENZEL, Bonn (DE); Hartmut WOLF, Königswinter (DE); Raimund HELMIG, Hoerstel (DE); Gero MIMBERG, Köln (DE); Jack HOOKER, Köln (DE)

(73) Assignee: KAUTEX TEXTRON GmbH & Co. KG, Bonn (DE)

(21) Appl. No.: 19/484,576

(22) PCT Filed: May 6, 2024
(86) PCT No.: PCT/EP2024/062439

§ 371 Date: Nov. 14, 2025

(30) Foreign Application Priority Data
May 16, 2023 (DE) 10 2023 112 942.2

(51) Int. Cl. H01M 50/238; H01M 50/213; H01M 50/249; H01M 50/291

(52) U.S. Cl. CPC H01M 50/238; H01M 50/249; H01M 50/291; H01M 50/213

(57) ABSTRACT

The invention relates to a battery housing for accommodating a plurality of battery components, comprising a first battery housing component, a second battery housing component, and at least one battery component holder having a plurality of receiving devices for receiving the battery components. The battery component holder is arranged in a sandwich-like manner between the first battery housing component and the second battery housing component and is connected to the first battery housing component and/or to the second battery housing component in a material-locking manner. The invention also relates to a battery comprising a battery housing and a motor vehicle comprising a battery.

The present invention relates to a battery housing for accommodating a plurality of battery components. Furthermore, the present invention relates to a battery with a battery housing and a motor vehicle with a battery.

New-generation batteries, especially traction batteries for motor vehicles, are often designed according to the “cell-to-pack” principle in order to increase energy density. This means that the battery cells are not installed in individual battery modules in the battery housing. Instead, the battery cells are installed directly in the battery housing. This is usually achieved by bonding the battery cells over their entire surface or completely embedding them in casting compounds. Medium-density polyurethane foams are typically used as casting compounds, which bond with the battery cells and the battery housing through adhesion. The casting compound acts as an electrical and thermal insulator between the battery cells and ensures sufficient torsional and bending stiffness of the battery. This allows the battery to be designed smaller than a conventional battery with battery modules for a given capacity.

However, these batteries have the disadvantage that the process of casting and curing the casting compound is technologically difficult to control and slow. This can result in casting compound getting into areas of the battery housing that are not intended for it. Another problem with these batteries is that the casting compound does not completely fill the areas in the battery housing intended for filling, which may impair the mechanical and thermal performance of the battery. In addition, the cured casting compound may have an inhomogeneous density distribution. Another disadvantage is the poor recyclability of the battery housing, which is due in particular to the complex separation of the materials in the battery housing.

These disadvantages are particularly pronounced in battery housings made of plastics or fiber-reinforced plastics. The plastic surfaces of the battery housing must be pretreated in a complex manner in order to achieve sufficient adhesion between the casting compound and the battery housing. In addition, subsequent separation of the casting compound and a battery housing made of plastic or fiber-reinforced plastic is even more difficult to achieve in the context of recycling than in the case of a battery housing made of metal.

The present invention is based on the problem of providing a battery housing for accommodating battery cells, which has improved torsional and bending stiffness and at the same time has improved recyclability.

The problem underlying the present invention is solved by a battery housing having the features of claim 1 of the present invention. Advantageous embodiments of the battery housing are described in the claims dependent on claim 1.

More specifically, the problem underlying the present invention is solved by a battery housing for accommodating a plurality of battery components, comprising a first battery housing component, a second battery housing component, and at least one battery component holder, comprising a plurality of receiving devices for receiving the battery components. The battery component holder is arranged in a sandwich-like manner between the first battery housing component and the second battery housing component, wherein the battery component holder is connected to the first battery housing component and/or to the second battery housing component in a material-locking manner.

The battery housing according to the invention has the advantage that the battery housing has an improved recyclability. By waiving the use of a casting compound in the battery housing, which is costly to process, it is possible to recycle the battery housing without costly separation processes to separate the casting compound from the battery housing components. Furthermore, the battery housing according to the invention has the advantage that the battery housing has improved torsional and bending stiffness. Because the battery component holder is connected to the first battery housing component and/or to the second battery housing component, the battery housing can absorb improved shear and bending forces. Finally, the battery housing according to the invention has the advantage that the battery housing has improved electrical and thermal insulation between battery components, in particular battery cells, that can be received in the battery housing.

The feature according to which the battery component holder is arranged in a sandwich-like manner between the first battery housing component and the second battery housing component can also be expressed as the battery component holder being arranged as a sandwich core between the first battery housing component and the second battery housing component. Consequently, the battery component holder can also be referred to as a sandwich core.

The first battery housing component is preferably designed as a battery housing shell. The first battery housing component can also be referred to as a battery housing lower shell or, more generally, as a lower shell.

The second battery housing component is preferably designed as a battery housing shell or as a battery housing cover, whereby the battery housing cover can also be designed as a battery housing shell. The second battery housing component can also be referred to as a battery housing upper shell or, in general, as an upper shell.

The receiving devices of the battery component holder are designed as receiving recesses and/or as through openings in the battery component holder.

A battery housing designed in this way has the advantage that the battery components can be easily accommodated in the receiving devices of the battery component holder of the battery housing.

The battery components are preferably designed as battery cells. The battery cells are preferably designed as cylindrical battery cells. It is also possible for the battery components to be designed as battery modules.

The battery housing is preferably designed as a traction battery housing for a traction battery of an electrically driven motor vehicle.

The traction battery housing is preferably mountable on a motor vehicle body.

Preferably, the receiving devices of the battery component holder have a receiving volume. The receiving volume is preferably at least partially limited by an inner wall of the receiving device.

Preferably, the receiving devices of the battery component holder have a first receiving opening and/or a second receiving opening. The first receiving opening is preferably arranged opposite a base surface of the first battery housing component. The second receiving opening is preferably arranged opposite a base surface of the second battery housing component. A battery component can be inserted into the receiving device through the first receiving opening or the second receiving opening.

The receiving devices of the battery component holder can also be referred to as receiving cavities.

Preferably, the receiving devices of the battery component holder have a free cross-section that is semicircular or circular in shape.

Preferably, the receiving devices of the battery component holder have a free cross-section that essentially corresponds to a cross-section of a battery component that can be received in the battery housing.

A battery housing designed in this way has the advantage that the battery components can be easily accommodated in the receiving devices of the battery component holder of the battery housing.

Preferably, the battery housing is designed such that the battery component holder has a plurality of connecting surfaces arranged on a front side of the battery component holder, wherein the battery component holder is connected to the first battery housing component and/or the second battery housing component by means of the plurality of connecting surfaces.

A battery housing designed in this way has the advantage that the battery housing has further improved torsional and bending Stiffness.

Preferably, the connecting surfaces are designed to be semicircular, circular, or linear. A battery housing designed in this way has the advantage that the battery component holder is better connected to the first battery housing component and/or the second battery housing component. As a result, the battery housing has further improved torsional and bending stiffness.

Preferably, the connecting surfaces are arranged circularly around the first receiving opening and/or around the second receiving opening of the receiving devices of the battery component holder.

Preferably, the battery component holder has at least one positioning device arranged on the front side of the battery component holder, wherein the positioning device of the battery component holder is received in a positioning receptacle of the first battery housing component and/or the second battery housing component corresponding to the positioning device.

A battery housing designed in this way has the advantage that the battery component holder can be positioned more effectively in the battery housing and connected to the first battery housing component and/or the second battery housing component. As a result, the battery housing has further improved torsional and bending stiffness.

A positioning device and a positioning receptacle correspond to each other if the positioning device can be accommodated in the positioning receptacle. In other words, the free cross-section of the positioning receptacle corresponds to the cross-section of the positioning device.

The positioning device is preferably designed as a positioning pin, with the positioning pin protruding from an end surface of the battery component holder. The positioning pin is preferably designed as a cylinder.

The positioning receptacle is preferably designed as a positioning recess, wherein the positioning recess is arranged on a base surface of the first battery housing component and/or on a base surface of the second battery housing component. The positioning recess preferably has a circular free cross-section so that a positioning pin designed as a cylinder can be accommodated in the positioning recess.

The battery housing is preferably designed such that the connecting surfaces of the battery component holder are each designed as connecting projections that protrude from an end surface of the battery component holder.

A battery housing designed in this way has the advantage that the battery housing has further improved torsional and bending stiffness.

Preferably, the connecting projections have a partial circular or circular cross-section in a top view of the end surface. In other words, the connecting projections can be designed as cylinders.

In the installation position of the battery housing, for example in a motor vehicle, the end surface of the battery component holder runs in a horizontal direction.

In the installation position of the battery housing, for example in a motor vehicle, the base surface of the first battery housing component and the base surface of the second battery housing component run in a horizontal direction. In particular, the end surface of the battery component holder and the base surface of the first battery housing component and the base surface of the second battery housing component run parallel to each other.

Preferably, the battery component holder has two end surfaces, wherein the two end surfaces are arranged at a distance from each other. In the installation position of the battery housing, for example in a motor vehicle, both end surfaces of the battery component holder run horizontally, with a first end surface arranged opposite the base surface of the first battery housing component and a second end surface arranged opposite the base surface of the second battery housing component.

Preferably, the battery housing is designed such that, in a top view of the end surface of the battery component holder, the connecting projections are arranged adjacent to three receiving devices.

A battery housing designed in this way has the advantage that the battery housing has further improved torsional and bending stiffness. The regular arrangement of the connecting projections on an end face allows the battery component holder to be connected in an improved sandwich-like manner to the first battery housing component and/or the second battery housing component.

Preferably, the battery housing is designed such that, in a top view of the end surface of the battery component holder, the connecting projections are arranged between two receiving devices of the battery component holder.

Preferably, the battery housing is designed such that the battery component holder is connected to the first battery housing component and/or the second battery housing component in a material-locking manner by means of welding and/or adhesive bonding.

A battery housing designed in this way has the advantage that the battery housing has improved torsional and bending stiffness.

Preferably, the welding between the battery component holder and the first battery housing component and/or the second battery housing component is produced by means of an ultrasonic welding process.

A battery housing designed in this way has the advantage that the battery housing has improved recycling efficiency. Due to the welding, there are no adhesive residues, so that the recycling process can be carried out less expensively.

Preferably, the battery housing is designed such that the first battery housing component has a plurality of connecting projections which are arranged on a base surface facing a receiving volume of the battery housing and extend into the receiving volume, and/or the second battery housing component has a plurality of connecting projections which are arranged on a base surface facing the receiving volume of the battery housing and extend into the receiving volume, wherein the battery component holder is connected to the first battery housing component and/or to the second battery housing component by means of the plurality of connecting projections.

A battery housing designed in this way has the advantage that the battery housing has further improved torsional and bending stiffness.

Preferably, the connecting projections have a partial circular or circular cross-section in a top view of an end surface. In other words, the connecting projections can be designed as cylinders.

Preferably, the battery housing is designed such that the battery component holder is additionally connected to the first battery housing component and/or to the second battery housing component in a form-fitting and/or force-fitting manner.

A battery housing designed in this way has the advantage that the battery housing has further improved torsional and bending stiffness.

Preferably, the battery component holder is additionally connected to the first battery housing component and/or the second battery housing component in a form-fitting and/or force-fitting manner by means of interlocking teeth and/or a rear grip and/or a clamping connection.

A battery housing designed in this way has the advantage that the battery housing has further improved torsional and bending stiffness and, at the same time, improved recyclability.

An interlocking connection and/or a rear grip and/or a clamping connection each have at least two connecting means that correspond to each other. Two connecting means that correspond to each other are designed to be connected to each other and to maintain this connection by force and/or form.

A toothing has at least two corresponding rows of teeth.

A rear grip can be designed as a clip connection. A clip connection has at least one clip and at least one clip receptacle corresponding to the clip. The clip receptacle can be designed as a receptacle recess, wherein the receptacle recess has at least one undercut that is designed to engage a clip received in the receptacle recess. Preferably, the receptacle recess has two undercuts.

A rear grip may be designed as a snap hook connection. A snap hook connection has at least one snap hook and a snap hook receptacle corresponding to the snap hook. The snap hook receptacle can be designed as a receiving recess, wherein the receiving recess has at least one undercut that is designed to engage behind a snap hook received in the receiving recess.

A clamping connection can be designed as a tenon-groove connection. A tenon-groove connection has at least one tenon, preferably a cylindrical tenon, and a receiving groove corresponding to the tenon. A cross-section of the tenon may be larger than a free cross-section of the corresponding receiving groove, so that a crush connection is formed between the tenon and the receiving groove when the tenon is received in the receiving groove.

Preferably, one of the corresponding connecting means of an interlocking connection and/or a rear grp and/or a clamping connection is formed monolithically with the battery component holder. The respective corresponding connecting means is preferably formed monolithically with the first battery housing component and/or with the second battery housing component.

Two monolithically connected components are made from the same component and, in particular, are connected to each other without joints.

A battery housing designed in this way has the advantage that the battery housing has further improved recyclability while also offering improved torsional and bending stiffness. Because the connecting elements are an integral part of the battery component holder and/or the first battery housing component and/or the second battery housing component, the battery housing has an even smaller number of different materials and is therefore even more efficiently recyclable. For example, after removal of the battery components and other electrical components, the battery housing can be mechanically crushed in one piece and further processed into recycled plastic.

Preferably, the battery housing is designed such that the battery component holder has a first battery component holder part and a second battery component holder part, wherein the first battery component holder part is connected to the first battery housing component in a material-locking manner and the second battery component holder part is connected to the second battery housing component in a material-locking manner. A first end face of the first battery component holder part is arranged opposite a second end face of the second battery component holder part and is connected to it.

A battery housing designed in this way has the advantage that battery components, in particular battery cells, can be arranged more easily in the battery housing and that the battery housing also has improved torsional and bending stiffness.

Preferably, the first battery component holder part is connected to the first battery housing component by welding and/or bonding. Alternatively or additionally, the first battery component holder part is preferably connected to the first battery housing component by a form-fitting and/or force-fitting connection. The form-fitting and/or force-fitting connection can be designed as an interlocking connection and/or as a rear grip and/or as a clamping connection.

Preferably, the second battery component holder part is connected to the second battery housing component by welding and/or bonding. Alternatively or additionally, the second battery component holder part is preferably connected to the second battery housing component in a form-fitting and/or force-fitting manner. The form-fitting and/or force-fitting connection can be designed as an interlocking and/or rear grip and/or as a clamping connection.

Preferably, the first end face of the first battery component holder part is connected to the second end face of the second battery component holder part in a material-locking manner, in particular by welding and/or adhesive bonding.

Preferably, the first end face of the first battery component holder part has connecting projections that protrude from the first end face. Preferably, the second end face of the second battery component holder part has connecting projections that protrude from the second end face.

Preferably, the first end face of the first battery component holder part is additionally or alternatively connected to the second end face of the second battery component holder part in a force-fitting manner, in particular by means of a clamping connection.

Preferably, the first end face of the first battery component holder part is additionally or alternatively connected to the second end face of the second battery component holder part in a form-fitting manner, in particular by means of a rear grip and/or a toothing connection.

In the installation position of the battery housing, for example in a motor vehicle, the first end face of the first battery component holder part and the second end face of the second battery component holder part run in a horizontal direction. In other words, the battery component holder has a horizontal separation which divides the battery component holder into a first battery component holder part and a second battery component holder part. In the installation position of the battery housing, for example in a motor vehicle, the first end face of the first battery component holder part and the second end face of the second battery component holder part run parallel to the base surface of the first battery housing component and to the base surface of the second battery housing component.

Preferably, the first battery component holder part and the second battery component holder part together form at least one receiving device. The receiving device may have a circular free cross-section. The receiving volume of the receiving device may be partially limited by an inner wall of the receiving device, wherein the inner wall is formed by a first inner wall section of the first battery component holder part and a second inner wall section of the second battery component holder part.

A battery housing designed in this way has the advantage that battery components, in particular battery cells, can be inserted into the battery component holder more easily.

Preferably, the battery housing is designed such that the first battery component holder part is formed monolithically with the first battery housing component and/or such that the second battery housing component holder part is formed monolithically with the second battery housing component.

A battery housing designed in this way has the advantage that the battery housing has improved recyclability and can be manufactured more easily, in particular in a single manufacturing step.

Preferably, the battery housing is designed such that the battery component holder has a third battery component holder part and a fourth battery component holder part, wherein the third battery component holder part is connected to the first battery housing component and/or to the second battery housing component in a material-locking manner, and wherein the fourth battery component holder part is connected to the first battery housing component and/or to the second battery housing component in a material-locking manner. The third battery component holder part has a third connecting means which is arranged on a third side surface of the third battery component holder part, and/or the fourth battery component holder part has a fourth connecting means which is arranged on a fourth side surface of the fourth battery component holder part. The third battery component holder part is connected to the fourth battery component holder part in a form-fitting manner by means of the third connecting means and/or by means of the fourth connecting means.

A battery housing designed in this way has the advantage that battery components, in particular battery cells, can be easily accommodated in the receptacles of the battery component holder of the battery housing, and that the battery housing also has improved torsional and bending stiffness.

Preferably, in the installation position of the battery housing in a motor vehicle and during intended use, the third battery component holder part is connected to the fourth battery component holder part horizontally or vertically in a form-fitting manner by means of the third connecting means and/or the fourth battery component holder part is connected to the third battery component holder part horizontally or vertically in a form-fitting manner by means of the fourth connecting means.

Preferably, the third battery component holder part is connected to the first battery housing component and/or to the second battery housing component in a material-locking manner by means of welding and/or adhesive bonding.

Preferably, the fourth battery component holder part is connected to the first battery housing component and/or to the second battery housing component by means of welding and/or adhesive bonding.

Alternatively or additionally, the third battery component holder part and/or the fourth battery component holder part is connected to the first battery housing component and/or to the second battery housing component in a form-fitting and/or force-fitting manner. The form-fitting and/or force-fitting connection can be designed as an interlocking connection and/or as a rear grip and/or as a clamping connection.

The third side surface and/or the fourth side surface is/are preferably arranged perpendicular to the first end surface of the first battery component holder part and/or to the second end surface of the second battery component holder part.

The third connecting means and the fourth connecting means preferably correspond to each other. For example, the third connecting means may be designed as a clip and the fourth connecting means as a clip receptacle corresponding to the clip. The clip receptacle may be designed as a receiving recess. The receiving recess is preferably designed in such a way that the clip is engaged from behind by the receiving recess when the clip is received in the receiving recess.

The third connecting means may be designed as a snap hook and the fourth connecting means may be designed as a snap hook receptacle corresponding to the snap hook. The snap hook receptacle may be designed as a receiving recess. The receiving recess is preferably designed such that the snap hook is engaged by the receiving recess when the snap hook is received in the receiving recess.

In an installation position of the battery housing, for example in a motor vehicle, the third side surface and the fourth side surface extend along a vertical direction. In particular, the third side surface of the third battery component holder part is arranged opposite a fourth side surface of the fourth battery component holder part and parallel thereto.

Preferably, the third battery component holder part and the fourth battery component holder part together form at least one receiving device. The receiving device may have a circular free cross-section. Preferably, the circular free cross-section of the receiving device is formed by the third battery component holder part and the fourth battery component holder part, wherein the third battery component holder part and the fourth battery component holder part each provide a semicircular section of the receiving device. The receiving volume of the receiving device can be partially limited by an inner wall of the receiving device, wherein the inner wall is formed by a third inner wall section of the third battery component holder part and a fourth inner wall section of the fourth battery component holder part.

Preferably, the battery housing is designed such that the third battery component holder part is formed monolithically with the first battery housing component and/or with the second battery housing component, and/or the fourth battery component holder part is formed monolithically with the first battery housing component and/or the second battery housing component.

A battery housing designed in this way has the advantage that battery cells can be arranged more easily in the battery housing and that the battery housing also has improved recyclability.

Preferably, the battery housing is designed such that the receiving devices each have a battery component support, wherein a clearance is formed between the respective battery component supports and a base surface of the first battery housing component.

A battery housing designed in this way has the advantage that battery components, in particular battery cells, can be arranged more easily in the battery housing and at the same time can be better temperature-controlled by a fluid flowing through the battery housing.

The battery component support is designed so that a battery component, in particular a battery cell, rests on the battery component support when inserted into the receiving device.

The battery component support can be designed as a narrowing of the receiving device. A battery component support designed in this way has a smaller free cross-section than the receiving device.

The battery component support may be designed as a separate component. For example, the battery component support may be designed as an insert with a smaller free cross-section than the receiving device and may be inserted into the receiving device. Alternatively, the battery component support may be monolithically connected to the battery component holder or the first battery housing component.

The clearance between the base surface of the first battery housing component and the battery components can, for example, be designed to accommodate a fluid, in particular a cooling fluid. The cooling fluid can be used to cool the battery components in the battery housing.

Preferably, the battery housing is designed such that at least one battery component support is designed as a projection that extends from an inner wall delimiting a receiving volume of the receiving device into the receiving volume, into which a battery component can be received, wherein the battery component support is elastically deformable, so that when a battery component is inserted into the receiving volume of the receiving device, the battery component support is deformed in the direction of the base surface of the first battery housing component.

The battery housing designed in this way has the advantage that battery components with different heights can be accommodated by the receiving device. This is because the deformation of the battery component support in the direction of the base surface of the first battery housing component extends the receiving volume of the receiving device. This means that variations in the length of battery components, which are often present due to manufacturing processes, can be better compensated for by the appropriately designed battery housing.

Preferably, the battery housing is designed in such a way that the battery component support is inclined relative to the inner wall in the direction of the base surface of the first battery housing component. Furthermore, the battery housing is preferably designed such that the battery component support is also inclined relative to the inner wall in the direction of the base surface of the first battery housing component, even without a battery component inserted into the receiving volume.

The battery housing designed in this way has further improved flexibility with regard to the height expansion of the battery components to be accommodated in the receiving device.

Preferably, the battery housing is designed such that at least one battery component support is designed as a rib that extends from an inner wall delimiting a receiving volume of the receiving device into the receiving volume, into which a battery component can be received, wherein the at least one rib is elastically deformable, so that when a battery component is inserted into the receiving volume of the receiving device, the at least one rib is deformed in the direction of the inner wall.

Furthermore, an outer edge of the rib is preferably inclined so that a lower region of the outer edge of the rib, which is adjacent to a base surface of the first battery housing component, has a greater distance to the inner wall than an upper region of the outer edge of the rib, which is adjacent to a base surface of the second battery housing component.

Preferably, the battery housing is designed such that a first receiving opening of the receiving device, which is arranged opposite a base surface of the first battery housing component, is closed by means of a bottom wall, wherein the bottom wall is designed in such a way that it ruptures when a predetermined force exerted on it is exceeded, such as that generated by a battery component inserted into the receiving device in the event of thermal runaway of the battery component.

The battery housing designed in this way has improved operational safety, as the gases produced in the event of thermal runaway of a battery component can be dissipated more effectively.

The bottom wall is preferably designed as a membrane. Furthermore, the bottom wall is preferably curved. Even more preferably, the bottom wall is curved in such a way that the surface of the bottom wall opposite the base surface of the first battery housing component is concave.

Preferably, the battery housing is designed such that the bottom wall has at least one predetermined breaking point, preferably a predetermined breaking line.

Preferably, the predetermined breaking point or predetermined breaking line are formed as a thin section of the bottom wall. For example, the predetermined breaking point or predetermined breaking line is the connection point or connection line of the bottom wall with the battery component holder.

Preferably, the battery housing is designed such that the first battery housing component has a plurality of projections extending from a base surface of the first battery housing component into a receiving volume of the battery housing, wherein the battery components can be placed on the projections so that a clearance is formed between the base surface of the first battery housing component and the battery components.

A battery housing designed in this way has the advantage that battery components, in particular battery cells, can be cooled more effectively by a fluid flowing through the battery housing, and that the battery housing also has improved recyclability.

The projections may be monolithically connected to the first battery housing component. The projections may be designed as cylinders.

The projections may form a first battery component holder part, which may also be referred to as a battery cell holder and/or cell holder.

The projections may each extend from the base surface of the first battery housing component into the receiving devices, in particular into the receiving volumes of the receiving devices.

Preferably, the battery housing is designed such that the battery housing has at least one adhesive device which is connected to an inner wall delimiting a receiving volume of the receiving device and is designed for adhesive connection to a battery component received in the receiving volume.

The battery housing designed in this way has the advantage that the battery components are more securely fastened in the battery component holder.

The adhesive device is preferably designed as adhesive tape, preferably double-sided adhesive tape.

Preferably, the adhesive device is designed to run around the entire circumference. This means that the adhesive device is arranged around the entire circumference of the inner wall.

Preferably, an adhesive device is arranged in a lower region of the inner wall, i.e., the adhesive device is arranged adjacent to a base surface of the first battery housing component.

It is further preferable for an adhesive device to be arranged in an upper region of the inner wall, i.e., for the adhesive device to be arranged adjacent to a base surface of the second battery housing component.

Preferably, the battery housing is designed such that the first battery housing component and/or the second battery housing component and/or the battery component holder comprise the same material or are formed from the same material or material mix.

A battery housing designed in this way has the advantage that the battery housing has even more improved recyclability.

The same material can be formed as a thermoplastic, in particular as polypropylene (PP), polycarbonate (PC), and/or polyamide (PA).

The same material can be formed as a foamed plastic. A battery housing designed in this way has the advantage that the battery housing has a reduced density and is therefore lighter, while at the same time having improved recyclability.

Alternatively, the same material can be formed as a solid plastic. A battery housing formed in this way has the advantage that the battery housing has further improved torsional and bending stiffness and, at the same time, improved recyclability.

The same material mix can comprise a plastic material as the matrix material and reinforcing fibers. The reinforcing fibers can be formed as glass fibers and/or carbon fibers and/or aramid fibers. The plastic material can be formed as a solid or foamed plastic, in particular as a thermoplastic such as PP, PC, or PA. A battery housing designed in this way has the advantage that the battery housing has further improved torsional and bending stiffness.

Preferably, the battery housing is designed such that the height of the battery component holder is greater than or equal to the height of the battery components.

A battery housing designed in this way has the advantage that battery components, in particular battery cells, can be positioned more effectively in the receiving devices of the battery component holder.

In the installation position of the battery housing, for example in a motor vehicle, the height of the battery components and the height of the battery component holder extend in a vertical direction.

The present invention is also based on the problem of providing a battery that has improved torsional and bending stiffness and, at the same time, improved recyclability.

This problem underlying the present invention is solved by a battery comprising a battery housing as described above, wherein the battery comprises a plurality of battery components, each of which is received in a receiving device of the battery component holder.

The present invention is also based on the problem of providing a motor vehicle that has a battery with improved recycling efficiency.

This problem underlying the present invention is solved by a motor vehicle with a battery described above, wherein the battery is energy-coupled to the electric drive motor of the motor vehicle.

Further advantages, details, and features of the invention are apparent from the following description of the embodiments. In particular, they show:

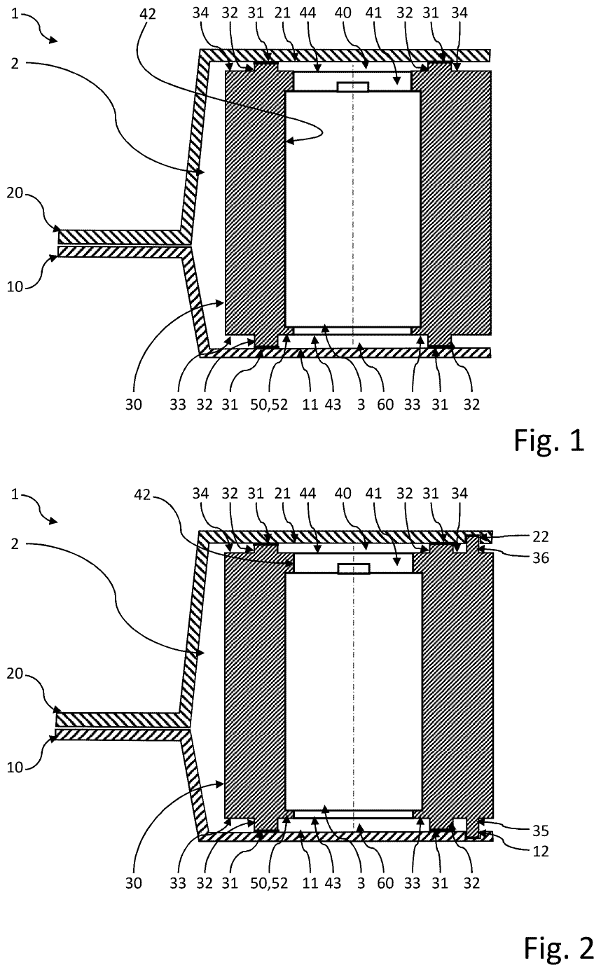

FIG. 1: a sectional view of a battery housing in the area of a receiving device according to a first embodiment;

FIG. 2: a sectional view of a battery housing in the area of a receiving device according to a second embodiment;

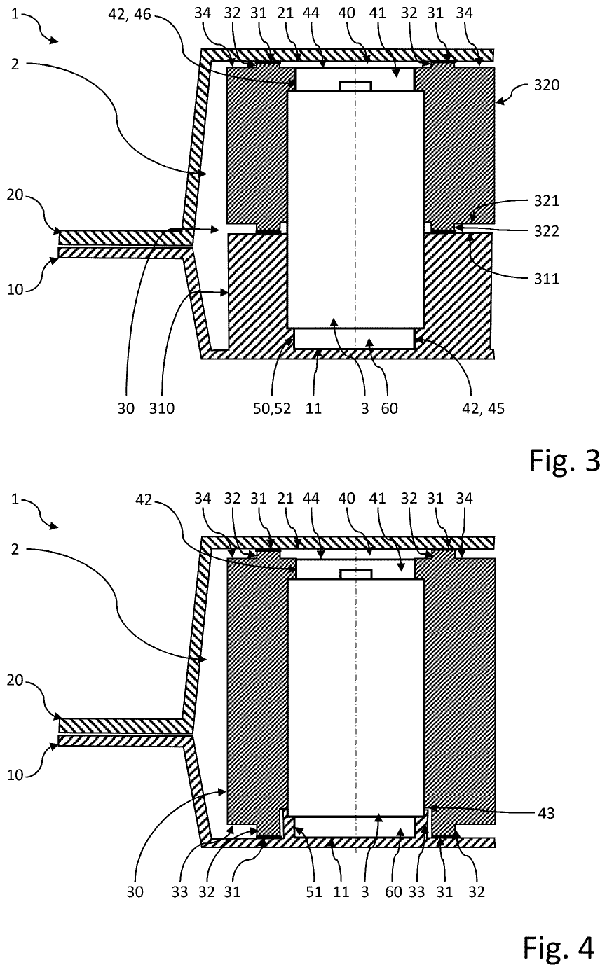

FIG. 3: a sectional view of a battery housing in the area of a receiving device according to a third embodiment;

FIG. 4: a sectional view of a battery housing in the area of a receiving device according to a fourth embodiment;

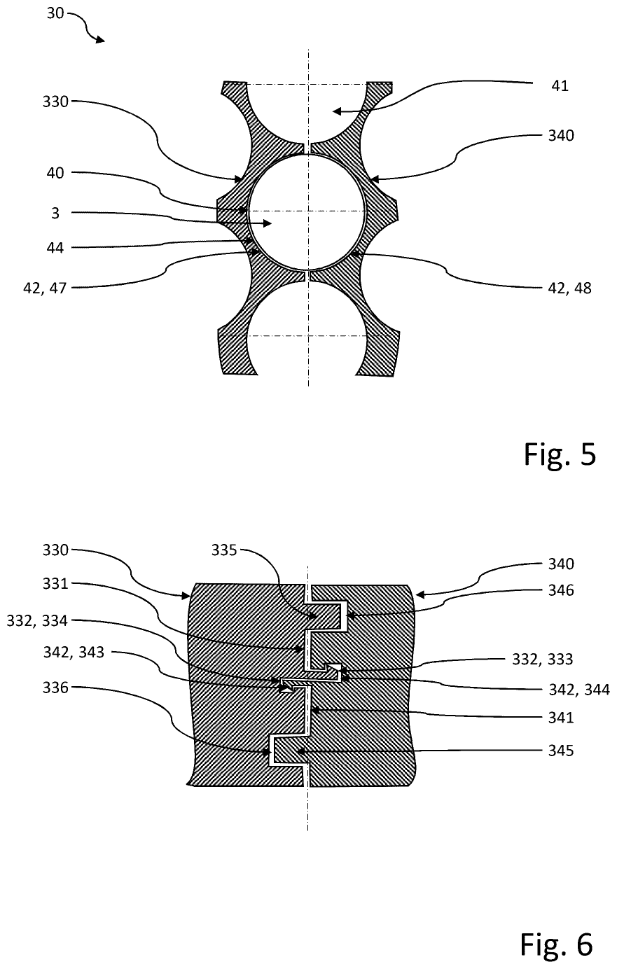

FIG. 5: a sectional view of a battery component holder of a battery housing according to a fifth embodiment;

FIG. 6: a sectional view of a battery component holder of a battery housing in the connection area of a third battery component holder part and a fourth battery component holder part according to a sixth embodiment;

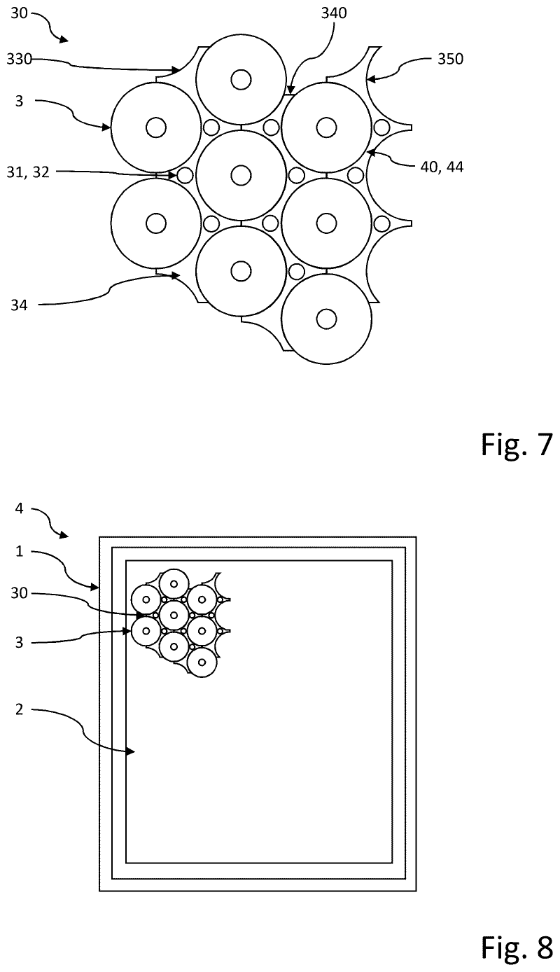

FIG. 7: a battery component holder of a battery housing according to a seventh embodiment in a top view;

FIG. 8: a battery comprising a battery housing according to an eighth embodiment in a top view;

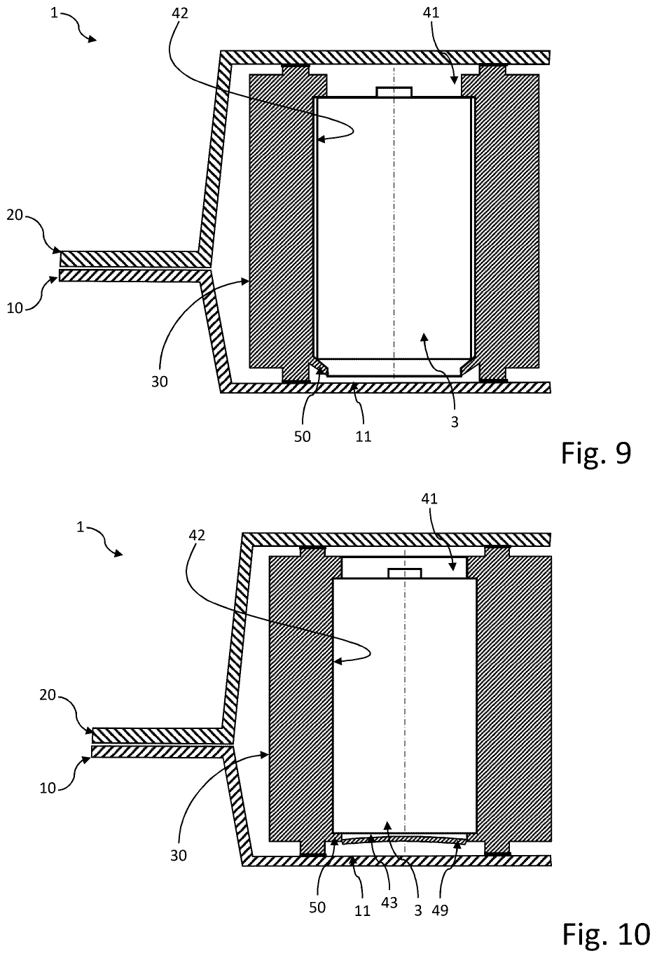

FIG. 9: a sectional view of a battery housing in the area of a receiving device according to a ninth embodiment;

FIG. 10: a sectional view of a battery housing in the area of a receiving device according to a tenth embodiment;

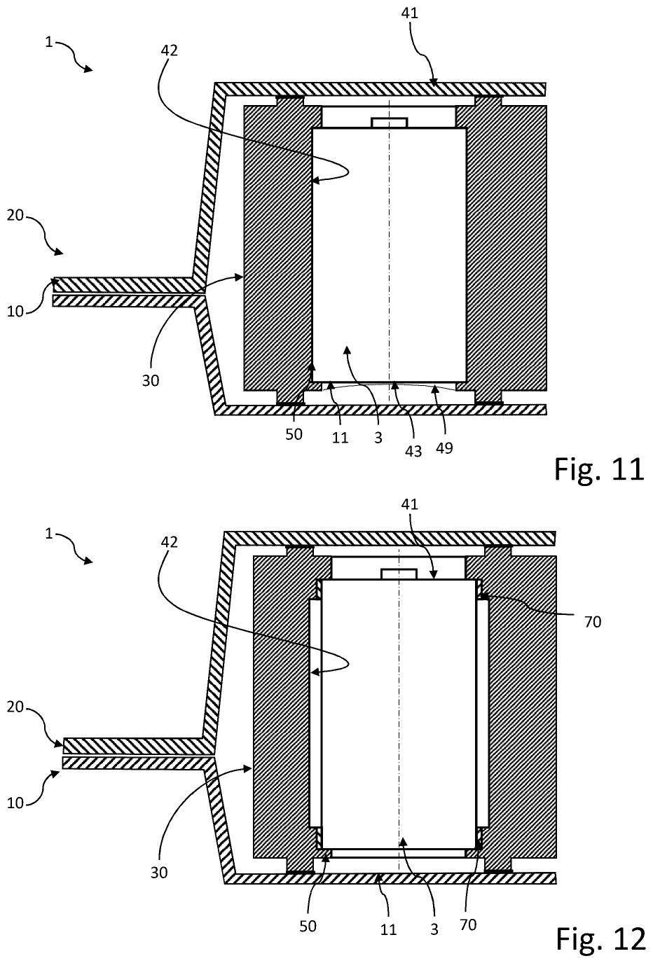

FIG. 11: a sectional view of a battery housing in the area of a receiving device according to an eleventh embodiment; and

FIG. 12: a sectional view of a battery housing in the area of a receiving device according to a twelfth embodiment.

In the following description, identical reference numerals denote identical components or identical features, so that a description of a component in relation to one figure also applies to the other figures, thereby avoiding repetitive descriptions. Furthermore, individual features described in connection with one embodiment can also be used separately in other embodiments.

FIG. 1 shows a sectional view of a battery housing 1 for accommodating a plurality of battery components 3 in the area of a receiving device 40 according to a first embodiment. The battery housing 1 has a first battery housing component 10 and a second battery housing component 20, which at least partially delimit a receiving volume 2 of the battery housing 1. Furthermore, the battery housing 1 has a battery component holder 30, which has a plurality of receiving devices 40 for receiving the battery components 3. The battery component holder 30 is arranged in a sandwich-like manner between the first battery housing component 10 and the second battery housing component 20 in the receiving volume 2 of the battery housing 1 and is connected to the first battery housing component 10 and to the second battery housing component 20 in a material-locking manner. Consequently, the battery component holder 30 is arranged as a sandwich core 30 between the first battery housing component 10 and the second battery housing component 20 in the receiving volume 2 of the battery housing 1 and is connected to the first battery housing component 10 and to the second battery housing component 20 in a material-locking manner.

The battery component holder 30 has a plurality of connecting surfaces 31 arranged on a front side of the battery component holder 30. The battery component holder 30 is connected to the first battery housing component 10 and to the second battery housing component 20 by means of the plurality of connecting surfaces 31. The connecting surfaces 31 of the battery component holder 30 are each designed as connecting projections 32, which each protrude from an end surface 33, 34 of the battery component holder 30.

The receiving device 40 of the battery component holder 30 has a receiving volume 41, which is partially limited by an inner wall 42 of the receiving device 40. The battery components 3 are received in the respective receiving volumes 41 of the receiving devices 40. The receiving device 40 of the battery component holder 30 has a circular free cross-section. The receiving device 40 also has a first receiving opening 43 and a second receiving opening 44 opposite the first receiving opening 43. The first receiving opening 43 is arranged opposite a base surface 11 of the first battery housing component 10, and the second receiving opening 44 is arranged opposite a base surface 21 of the second battery housing component 20.

The receiving device 40 has a battery component support 50 on which the battery component 3 rests. A clearance 60 is formed between the battery component support 50 and the base surface 11 of the first battery housing component 10. The clearance 60 is designed to accommodate cooling fluid for cooling the battery component 3. The battery component support 50 is designed as a narrowing 52 of the receiving device 40.

FIG. 2 shows a sectional view of a battery housing 1 for accommodating a plurality of battery components 3 in the area of a receiving device 40 according to a second embodiment. The battery component holder 30 has two positioning devices 35, 36 which are arranged at the front side of the battery component holder 30. The positioning devices 35, 36 are designed as positioning pins, wherein the positioning pins are designed as cylinders. The positioning devices 35, 36 are monolithically connected to the battery component holder 30. A first positioning device 35 protrudes from a first end surface 33 of the battery component holder 30 and is received in a corresponding first positioning receptacle 12 of the first battery housing component 10. A second positioning device 36 protrudes from a second end surface 34 of the battery component holder 30 and is received in a corresponding second positioning receptacle 22 of the second battery housing component 20. The positioning receptacles 12, 22 are each designed as positioning recesses.

FIG. 3 shows a cross-sectional view of a battery housing 1 in the area of a receiving device 40 for receiving a plurality of battery components 3 according to a third embodiment. The battery component holder 30 has a first battery component holder part 310 and a second battery component holder part 320, wherein the first battery component holder part 310 is integrally connected to the first battery housing component 10 and the second battery component holder part 320 is integrally connected to the second battery housing component 20. A first end face 311 of the first battery component holder part 310 is arranged opposite a second end face 321 of the second battery component holder part 320 and is connected to it.

The second end face 321 of the second battery component holder part 320 has connecting projections 322 which protrude from the second end face 321 and are integrally connected to the first end face 311 of the first battery component holder part 310.

The first battery component holder part 310 is formed monolithically with the first battery housing component 10.

In the installation position of the battery housing 1 shown in FIG. 3, the first end face 311 of the first battery component holder part 310 and the second end face 321 of the second battery component holder part 320 extend in a horizontal direction. In other words, the battery component holder 30 has a horizontal separation that separates the battery component holder 30 into the first battery component holder part 310 and the second battery component holder part 320.

The first battery component holder part 310 and the second battery component holder part 320 together form the receiving device 40, wherein the inner wall 42 of the receiving device 40 is formed by a first inner wall section 45 of the first battery component holder part 310 and by a second inner wall section 46 of the second battery component holder part 320. The receiving device 40 has a circularly formed free cross-section.

FIG. 4 shows a sectional view of a battery housing 1 for accommodating a plurality of battery components 3 in the area of a receiving device 40 according to a fourth embodiment. The first battery housing component 10 has a plurality of projections 51 extending from a base surface 11 of the first battery housing component 10 into a receiving volume 2 of the battery housing 1, wherein the battery components 3 can be placed on the projections 51 so that a clearance 60 is formed between the base surface 11 of the first battery housing component 10 and the battery components 2. The projections 51 form a battery cell holder. The clearance 60 is designed to accommodate cooling fluid.

FIG. 5 shows a sectional view of a battery component holder 30 of a battery housing 1 according to a fifth embodiment. The battery component holder 30 has a third battery component holder part 330 and a fourth battery component holder part 340. The third battery component holder part 330 can be connected in a material-locking manner to the first battery housing component 10, which is not shown in FIG. 5, and/or to the second battery housing component 20, which is not shown in FIG. 5, and the fourth battery component holder part 340 can be connected in a material-locking manner to the first battery housing component 10 not shown in FIG. 5 and/or to the second battery housing component 20 not shown in FIG. 5.

The third battery component holder part 330 and the fourth battery component holder part 340 together form at least one receiving device 40 of the battery component holder 30, wherein the inner wall 42 is formed by a third inner wall section 47 and a fourth inner wall section 48.

FIG. 6 shows a cross-sectional view of a battery component holder 30 of a battery housing 1 in the connection area of a third battery component holder part 330 and a fourth battery component holder part 340 according to a sixth embodiment. The third battery component holder part 330 has two third connecting means 332 arranged on a third side surface 331 of the third battery component holder part 330, and the fourth battery component holder part 340 has two fourth connecting means 342 which are arranged on a fourth side surface 341 of the fourth battery component holder part 340, wherein the third battery component holder part 330 is connected to the fourth battery component holder part 340 by means of the third connecting means 332 and by means of the fourth connecting means 342 in a form-fitting manner.

A third connecting means 332 is designed as a snap hook 333 and a fourth connecting means 342 is designed as a corresponding fourth snap hook receptacle 344. The further fourth connecting means 342 is designed as a snap hook 343 and the further third connecting means 332 is designed as a corresponding third snap hook receptacle 334.

The third battery component holder part 330 has a third positioning pin 335, which is arranged on the third side surface 331 and is form-fittingly connected to a fourth receiving recess 346, which is arranged on the fourth side surface 341 of the fourth battery component holder part 340. In the installation position and during intended use of the battery housing 1, the third positioning pin 335 is connected to the fourth receiving recess 346 in a vertically form-fitting manner.

The fourth battery component holder part 340 has a fourth positioning pin 345, which is arranged on the fourth side surface 341 and is form-fittingly connected to a third receiving recess 336, which is arranged on the third side surface 331 of the third battery component holder part 330. In the installation position and during intended use of the battery housing 1, the fourth positioning pin 345 is vertically form-fittingly connected to the third receiving recess 336.

FIG. 7 shows a battery component holder 30 of a battery housing 1 according to a seventh embodiment in a top view. The battery component holder 30 has connecting projections 32 that protrude from a second end surface 34 and are arranged adjacent to three receiving devices 40. The connecting projections 32 are arranged in a circle at equidistant intervals around the second receiving opening 44 of the receiving device 40.

In addition to the third battery component holder part 330 and the fourth battery component holder part 340, the battery component holder 30 has a fifth battery component holder part 350. The fourth battery component holder part 340 is connected to the fifth battery component holder part 350 in the same manner as the fourth battery component holder part 340 is connected to the third battery component holder part 330. The battery component holder 30 may have further battery component holder parts.

FIG. 8 shows a battery 4 comprising a battery housing 1 according to an eighth embodiment in a top view. The battery 4 comprises a plurality of battery components 3 which are accommodated in the battery component holder 30, wherein the battery component holder 30 is arranged in the receiving volume 2 of the battery housing 1.

FIG. 9 shows a sectional view of a battery housing 1 for accommodating a plurality of battery components 3 in the area of a receiving device 40 according to a ninth embodiment. The battery component support 50 is designed as a projection 50 or as a plurality of projections 50, which extend from the inner wall 42 delimiting the receiving volume 41 of the receiving device 40 into the receiving volume 41, into which a battery component 3 can be received. The structure of the battery housing 1 shown in FIG. 9 corresponds to that of the battery housing 1 shown in FIG. 1, wherein the battery component support 50 is elastically deformable so that, when a battery component 3 is inserted into the receiving volume 41 of the receiving device 40, the battery component support 50 is deformed in the direction of the base surface 11 of the first battery housing component 10.

In the battery housing 1 shown in FIG. 9, the battery component support 50 is inclined relative to the inner wall 42 in the direction of the base surface 11 of the first battery housing component 10, even without a battery component 3 inserted into the receiving volume 41.

FIG. 10 shows a sectional view of a battery housing 1 for accommodating a plurality of battery components 3 in the area of a receiving device 40 according to a tenth embodiment. The first receiving opening 43 of the receiving device 40, which is arranged opposite the base surface 11 of the first battery housing component 10, is closed by means of a bottom wall 49, wherein the bottom wall 49 is designed such that it ruptures when a predetermined force exerted on it is exceeded, such as that generated by a battery component 3 inserted into the receiving device 40 in the event of thermal runaway of the battery component 3. For this purpose, the bottom wall 49 has a predetermined breaking line, which in the embodiment shown is designed as a thin spot in the connection between the bottom wall 49 and the battery component support 50. The remaining structure of the battery housing 1 shown in FIG. 10 corresponds to the battery housing 1 shown in FIG. 1.

FIG. 11 shows a sectional view of a battery housing 1 for accommodating a plurality of battery components 3 in the area of a receiving device 40 according to an eleventh embodiment. The battery housing 1 shown in FIG. 11 corresponds to the battery housing 1 shown in FIG. 10, except that the bottom wall 49 is designed as a membrane 49.

FIG. 12 shows a sectional view of a battery housing 1 for accommodating a plurality of battery components 3 in the area of a receiving device 40 according to a twelfth embodiment. The battery housing 1 shown in FIG. 12 has at least one adhesive device 70 which is connected to the inner wall 42 delimiting the receiving volume 41 of the receiving device 40 and is designed for adhesive connection to a battery component 3 received in the receiving volume 41. In the embodiment shown, the battery housing 1 has two adhesive devices 70, each of which is designed as adhesive tape 70. A first adhesive tape 70 is arranged in a lower region of the inner wall 42 so that the first adhesive tape 70 is arranged adjacent to the base surface 11 of the first battery housing component 10. A second adhesive tape 70 is arranged in an upper region of the inner wall 42, so that the second adhesive tape 70 is arranged adjacent to the base surface 21 of the second battery housing component 20. A free space is formed between the inner wall 42, which runs between the first adhesive tape 70 and the second adhesive tape 70, and the battery component 3. The remaining structure of the battery housing 1 shown in FIG. 12 corresponds to the battery housing 1 shown in FIG. 1.

### LIST OF REFERENCE NUMERALS

1 Battery housing
2 Receiving volume (of the battery housing)
3 Battery component
4 Battery
10 First battery housing component
11 Base surface (of the first battery housing component)
12 First positioning receptacle (of the first battery housing component)
20 Second battery housing component
21 Base surface (of the second battery housing component)
22 Second positioning receptacle (of the second battery housing component)
30 Battery component holder
31 Connecting surfaces
32 Connecting projection (of the battery component holder)
33 First end surface
34 Second end surface
35 First positioning device (of the battery component holder)
36 Second positioning device (of the battery component holder)
310 First battery component holder part
311 First end face (of the first battery component holder part)
320 Second battery component holder part
321 Second end face (of the second battery component holder part)
322 Connecting projection (of the second battery component holder part)
330 Third battery component holder part
331 Third side surface (of the third battery component holder part)
332 Third connecting means
333 Third snap hook
334 Third snap hook receptacle
335 Third positioning pin
336 Third receiving recess
340 Fourth battery component holder part
341 Fourth side surface (of the fourth battery component holder part)
342 Fourth connecting means
343 Fourth snap hook
344 Fourth snap hook receptacle
345 Fourth positioning pin
346 Fourth receiving recess
350 Fifth battery component holder part
40 Receiving device
41 Receiving volume (of the receiving device)
42 Inner wall (of the receiving device)
43 First receiving opening (of the receiving device)
44 Second receiving opening (of the receiving device)
45 First inner wall section
46 Second inner wall section
47 Third inner wall section
48 Fourth inner wall section
49 Bottom wall/membrane
50 Battery component support
51 Projection
52 Narrowing (of the receiving device)
60 Clearance (between the base surface of the first battery housing component and the battery components)
70 Adhesive device/adhesive tape

1. A battery housing for accommodating a plurality of battery components, comprising
a first battery housing component;
a second battery housing component;
at least one battery component holder comprising a plurality of receiving devices for receiving the battery components,
wherein the battery housing is characterized by the following features:
the battery component holder is arranged in a sandwich-like manner between the first battery housing component and the second battery housing component; and
the battery component holder is connected to the first battery housing component and/or to the second battery housing component in a material-locking manner.

2. The battery housing according to claim 1, characterized by the following features:
the battery component holder has a plurality of connecting surfaces arranged on a front side of the battery component holder; and
the battery component holder is connected to the first battery housing component and/or to the second battery housing component by means of the plurality of connecting surfaces.

3. The battery housing according to claim 2, characterized in that the connecting surfaces of the battery component holder are each designed as connecting projections that protrude from an end surface of the battery component holder.

4. The battery housing according to claim 3, characterized in that, in a top view of the end surface of the battery component holder, the connecting projections are arranged adjacent to three receiving devices.

5. The battery housing according to claim 1, characterized by the following features:
the first battery housing component has a plurality of connecting projections which are arranged on a base surface facing a receiving volume of the battery housing and extend into the receiving volume; and/or
the second battery housing component has a plurality of connecting projections arranged on a base surface facing the receiving volume of the battery housing and extend into the receiving volume; and
the battery component holder is connected to the first battery housing component and/or to the second battery housing component by means of the plurality of connecting projections.

6. The battery housing according to claim 1, characterized in that the battery component holder is additionally connected to the first battery housing component and/or to the second battery housing component in a form-fitting and/or force-fitting manner.

7. The battery housing according to claim 1, characterized by the following features:
the battery component holder has a first battery component holder part and a second battery component holder part;
the first battery component holder part is connected to the first battery housing component in a material-locking manner and the second battery component holder part is connected to the second battery housing component in a material-locking manner;
a first end face of the first battery component holder part is arranged opposite a second end face of the second battery component holder part and is connected to it.

8. The battery housing according to claim 7, characterized by the following features:
the first battery component holder part is formed monolithically with the first battery housing component; and/or the second battery component holder part is formed monolithically with the second battery housing component.

9. The battery housing according to claim 1, characterized by the following features:
the battery component holder has a third battery component holder part and a fourth battery component holder part;
the third battery component holder part is connected to the first battery housing component and/or to the second battery housing component in a material-locking manner, and the fourth battery component holder part is connected to the first battery housing component and/or to the second battery housing component in a material-locking manner;
the third battery component holder part has a third connecting means which is arranged on a third side surface of the third battery component holder part, and/or the fourth battery component holder part has a fourth connecting means which is arranged on a fourth side surface of the fourth battery component holder part;
the third battery component holder part is connected to the fourth battery component holder part by means of the third connecting means and/or by means of the fourth connecting means in a form-fitting manner.

10. The battery housing according to claim 9, characterized by the following features:
the third battery component holder part is formed monolithically with the first battery housing component and/or with the second battery housing component; and/or the fourth battery component holder part is formed monolithically with the first battery housing component and/or the second battery housing component.

11. The battery housing according to claim 1, characterized by the following features:
the receiving devices each have a battery component support; and
a clearance is formed between the respective battery component supports and a base surface of the first battery housing component.

12. The battery housing according to claim 11, characterized by the following features:
at least one battery component support is designed as a projection which extends from an inner wall delimiting a receiving volume of the receiving device into the receiving volume, into which a battery component can be received; and
the battery component support is elastically deformable so that, when a battery component is inserted into the receiving volume of the receiving device, the battery component support is deformed in the direction of the base surface of the first battery housing component.

13. The battery housing according to claim 11, characterized by the following features:
at least one battery component support is designed as a rib which extends from an inner wall delimiting a receiving volume of the receiving device into the receiving volume in which a battery component can be received; and
the at least one rib is elastically deformable so that, when a battery component is inserted into the receiving volume of the receiving device, the at least one rib is deformed in the direction of the inner wall.

14. The battery housing according to claim 1, characterized by the following features:
a first receiving opening of the receiving device, which is arranged opposite a base surface of the first battery housing component, is closed by means of a bottom wall; and
the bottom wall is designed in such a way that it ruptures when a predetermined force exerted on it is exceeded, such as that generated by a battery component inserted into the receiving device in the event of thermal runaway of the battery component.

15. The battery housing according to claim 13, characterized in that the bottom wall has at least one predetermined breaking point.

16. The battery housing according to claim 1, characterized by the following features:
the first battery housing component has a plurality of projections extending from a base surface of the first battery housing component into a receiving volume of the battery housing;
the battery components can be placed on the projections so that a clearance is formed between the base surface of the first battery housing component and the battery components.

17. The battery housing according to claim 1, characterized in that the battery housing has at least one adhesive device which is connected to an inner wall delimiting a receiving volume of the receiving device and is designed for adhesive connection to a battery component received in the receiving volume.

18. The battery housing according to claim 1, characterized in that the first battery housing component and/or the second battery housing component and/or the battery component holder comprise the same material or are formed from the same material or material mix.

19. The battery housing according to claim 1, characterized in that a height extension of the battery component holder is greater than or equal to a height extension of the battery components.

20. A battery, comprising
the battery housing according to claim 1; and
the plurality of battery components, each of which is received in the receiving device of the battery component holder.

21. A motor vehicle with the battery according to claim 20, wherein the battery is energy-coupled to an electric drive motor of the motor vehicle.
